(19) United States
(12) Patent Application Publication
(10) Pub. No.: US 2018/0050414 A1
(43) Pub. Date: Feb. 22, 2018

(54) WELDING SYSTEM USED WITH ADDITIVE MANUFACTURING

(71) Applicant: Camarc LLC, Westland, MI (US)

(72) Inventor: Russell Vernon Hughes, Plymouth, MI (US)

(21) Appl. No.: 15/679,466

(22) Filed: Aug. 17, 2017

Related U.S. Application Data
(60) Provisional application No. 62/376,551, filed on Aug. 18, 2016.

(51) Int. Cl. B23K 9/12; B23K 10/02; B23K 9/09; B33Y 30/00

(52) U.S. Cl. CPC B23K 9/123; B23K 9/121; B33Y 10/00; B23K 9/09; B33Y 30/00; B23K 10/02

(57) ABSTRACT

A plasma arc welding system includes at least two wire delivery mechanisms and at least two wires. Each of the two wires is delivered by one of the at least two wire delivery mechanisms.

### REFERENCED TO RELATED APPLICATIONS

This application claims priority to U.S. Provisional Patent Application No. 62/376,551 filed on Aug. 18, 2016.

### BACKGROUND

FIG. 1 illustrates a plasma arc welding torch assembly 10. A plasma arc 12 is generated between a plasma arc welding torch 14 and a piece (or pieces) of parent metal 16. Traversing of the plasma arc 12, while operating at appropriate conditions across the parent metal 16, will cause localized melting of the parent metal 16. A filler wire guiding mechanism 18 (wire guide or bracket) directs filler wire 20 to be added to the domain of the high temperature plasma arc 12 to produce a reinforced weld bead 22 on a surface of the parent metal 16. A width 23 and a height 24 of the deposit or weld bead 22 are determined by the amount of filler wire 20 added and the rate of relative motion between the plasma arc welding torch 14 and the parent metal 16.

If the weld bead 22 does not join two or more members of parent metal 16, the technique is commonly referred to as “cladding.” In most cladding operations, a process is performed to confer a “coating” on the surface of the parent metal 16. For example, the deposition of the filler wire 20 made of stainless steel in the weld bead 22 on the surface of a low carbon steel parent metal 16 can confer a high degree of corrosion resistance to the underlying parent metal 16 in the area where its surface is directly underneath and fused to the stainless steel deposit. By creating many overlapping welds, the entire surface of an otherwise corrosion prone parent metal 16 can be rendered highly corrosion resistant. The wire can be made of several materials to provide properties such as corrosion resistance, high hardness, thermal resistance, impact and/or abrasion resistance on a relatively low cost substrate. This enhances the properties of the parent metal 16, while reducing costs or the difficulty of making the entire part from the conferring material.

It is desirous to minimize mixing of the parent metal 16 and the filler wire 20 because excessive mixing can lead to the dilution of the properties of the filler wire 20, rendering the finished deposit less effective at performing its intended task. It is important that the balance between the heat input from the plasma arc 12 and the addition of the filler wire 20 is maintained so that excessive melting and dilution with the parent metal 16 is minimized so the resultant deposit can meet requirements. However, this creates a problem. Productivity demands placed on the technique to maximize the rate that the filler wire 20 is deposited requires that high levels of heat be generated by the plasma arc 12. At elevated levels, the plasma arc 12, being an electrical conductor, is surrounded by a powerful rotating magnetic field that imbues a weld pool with significant turbulence or stirring. This causes an increased level of dilution of the parent metal 16 and the filler wire 20. Therefore, the deposition rate for the filler wire 20 is limited to about 2 kilograms per hour if dilution levels are to remain acceptable.

To improve the rates of metal deposition, while keeping dilution low, several techniques have evolved. These techniques involve heating the filler wire 20 closer to its melting temperature before it reaches the weld pool, which places a lower demand on the melting action derived from the plasma arc 12.

FIG. 2 illustrates the plasma arc welding torch assembly 10 with the filler wire 20 pre-heated by a direct current (DC) power source 30 that improves rates of metal deposition. The filler wire 20 is pre-heated using its electrical resistance properties. In addition to the elements in FIG. 1, the welding torch assembly 10 includes a low voltage (typically 12 volt output) direct current power source 30 (for example, capable of delivering up to 200 amperes of current) connected between the filler wire guiding mechanism 18 and the parent metal 16. The filler wire guiding mechanism 18 includes an electrically conductive contact tip 39. A positive supply cable 33 and a negative supply cable 35 from the direct current power source 30 are affixed to the electrically conductive filler wire guiding mechanism 18 and parent metal 16, respectively.

An electrically insulative filler wire guiding mechanism 37 (wire guide or bracket) is attached to the plasma arc welding torch 14 to ensure that the current from the direct current power source 30 will flow through the negative supply cable 35, between a point of impingement of the filler wire 20 in the weld pool, through the filler wire 20, though the contact tip 39, through the filler wire guiding mechanism 18, through the positive supply cable 33, and to the electrically positive connection of the direct current power source 30.

The filler wire contact tip 39 and the filler wire guiding mechanism 18 are traditionally the positive pole, and the parent metal 16 is traditionally the negative pole as approximately ⅔ of the heating effect can occur at the contact tip 39 and approximately only ⅓ of the heating effect can occur at the point of impingement of the filler wire 20 and the parent metal 16. This connection maximizes the electrical energy input that resistance heats the filler wire 20, while keeping the heat evolved at the parent metal 16 to a minimum. As a result, dilution of the filler wire 20 with the parent metal 16 is minimized.

Sufficient heating current can be made to flow through the filler wire 20 to increase its temperature to at least several hundred degrees Celsius or more to either reduce the demand for melting the filler wire 20 on the plasma arc 12 itself or enable a significant increase in the rate the filler wire 20 can be melted and deposited on the parent metal 16, without risking excessive dilution if the power of the plasma arc 12 is kept at its maximum safe level commensurate with controlling dilution. That is, when using direct current resistive wire heating, the deposition rates of the filler wire 20 can be doubled from 2 kilograms per hour for a cold wire to 4 kilograms per hour for a resistively heated wire with little or no increase in dilution.

There are some drawbacks to heating the filler wire 20 with direct current. First, each of the electrical conductors, the plasma arc 12, and the electrically heated filler wire 20 are encompassed by rotating magnetic fields whose polarity and direction generate significant inter-reactive forces. Even when heated to a high temperature, the filler wire 20 is relatively rigid compared to the “flexible” or “weak” plasma arc column, which can negatively impact the column of the plasma arc 12. As the heating current through the filler wire 20 increases, a larger force field is generated that easily deflects the course of the plasma arc 12 from the plasma arc welding torch 14 towards the parent metal 16.

The resultant deviance of the plasma arc 12 from its intended path causes the weld puddle to move relative to the filler wire 20 and causes an undesirable loss of process stability (called “arc blow”). “Arc blow” is common when trying to operate welding arcs in the presence of external magnetic fields. “Arc blow” can cause deviance in the intended position of the weld deposit. In an extreme case, the magnetic field created when the filler wire 20 is electrically resistance heated could extinguish the plasma arc 12.

FIG. 3 illustrates the plasma arc welding torch assembly 10 with the filler wire 20 pre-heated with an alternating current (AC) low voltage power source having constant characteristics, which is a commonly employed to combat “arc blow.” As the polarity of the wire heating current alternates, the magnetic field surrounding the filler wire 20 reverses its direction of rotation, which in turn alternates the direction of the force applied to the plasma arc 12. The net effect is that the rising, collapsing and then reversing magnetic field around the filler wire 20 causes a weaving motion (or “arc weaving”) to be applied to the plasma arc 12. The frequency at which plasma arc weaving occurs matches the frequency of the alternating current applied to heat the filler wire 20. In the United States, alternating current power sources designed to operate on the domestic electrical grid operate at a frequency of 60 Hertz. In Europe, the electrical grid is at a frequency of 50 Hertz.

There are drawbacks to using an alternating current power source to heat the filler wire 20. First, because the plasma arc 12 is forced into a weaving motion, the increased turbulence of the molten weld pool can lead to increased dilution of the filler wire 20 with the parent metal 16. Additionally, the heat evolved is split equally between the parent metal 16 and the contact tip 39, as opposed to the direct current heating method where ⅔ of the heat can be generated at the contact tip 39, and therefore within the filler wire 20, provided the contact tip 39 is the positive connection. The weaving motion of the plasma arc 12 engendered when an alternating current power source is used tends to create a noticeably wider and reduced height weld deposit because the molten weld puddle is pulled by the plasma arc 12 as it sweeps due to the alternating magnetic field. In weld cladding operations where an entire surface of the parent metal 16 may need to be covered in multiple overlapping weld passes, an increased weld deposit width can be advantageous.

In “additive manufacturing” (3D printing), multiple layers of weld metal are deposited predominantly on top of one another to build up “walls” of material or three dimensional objects. Usually, consecutive weld passes of minimal width are very accurately deposited for the purpose of additively manufacturing the object.

FIG. 4(a) illustrates a section through a built up a profile of multiple weld passes layers 32, 34, 36, 38, 40, 42 and 44 created by plasma arc welding using added filler wire 20 to additively manufacture an object 45. A first layer 32 is typically deposited on a sacrificial piece of parent metal 46. A second layer 34 is then deposited on top of the first layer 32 and so on with more layers until a final layer 44 has been deposited. Each layer is symmetrically deposited about the center line CL1. After deposition of the layers 32, 34, 36, 38, 40, 42 and 44 is complete, a minimal amount of material outside the dotted lines is machined off in the areas marked A and B to provide a desired final width X, resulting in a smooth sided vertical wall of material free of voids and having the width X across its entire section. Only a very small volume of material needs to be removed to reach the required width X. This minimizes machining time, maximizes productivity, and keeps wastage in the form of swarf to a minimum. However, commercial pressures to elevate metal deposition rates in additive manufacturing encourages the implementation of the wire heating techniques previously described. However, these methods can also have problems.

FIG. 4b illustrates the “arc blow” deflection phenomenon associated with direct current heating of the filler wire 20 created by plasma arc welding using added filler wire 20 to additively manufacture an object 45. The center line CL1 denotes the desired center line of successive weld deposits. Deflection of the plasma arc 12 and therefore the weld puddle by the magnetic field surrounding the direct current heated filler wire causes the actual center line CL2 of the weld bead to be offset relative to the desired center line CL1. The offset, or positioning error, is indicated by a distance Y. As the dotted line boundaries indicating the width X do not encompass the deposited layers, excess amounts of material in a zone C needs to be machined off. In a zone D, there is a deficiency in the deposit where there is insufficient material within the boundaries indicated by the width X. Lack of material in the zone D could render the additively manufactured part to be scrap.

FIG. 4c illustrates a section through a deposit created with alternating current heating of the filler wire 20 created by plasma arc welding using added filler wire 20 to additively manufacture an object 45. The “arc weaving” motion of the plasma arc 12 causes the deposition of a wider weld bead than needed. As the finished machined width X is desired, the excessive bead width in zones E and F represent excessive amounts of material that must be machined away for the finished part to conform to specification. This results in more machining time, loss of productivity, and the production of unnecessary amounts of scrap material in the form of swarf.

The filler wire 20 is stored on a spool. When the filler wire 20 is de-spooled, it has a “cast” or natural curvature resulting from the filler wire 20 being wound on the spool. The filler wire 20 exits the contact tip 39 directly into the weld pool. For the filler wire 20 to pass through a bore of the contact tip 39 unimpeded, the bore must be about 0.1 mm to 0.2 mm larger than a diameter of the filler wire 20. This clearance can cause some small, but significant, variance in a position of the filler wire 20 as it arrives in the weld pool (which is typically about 20 mm to 30 mm from an exit of the contact tip 39). The positional variation is also impacted by the cast of the filler wire 20 and the wear experienced in the bore of the contact tip 39. When a curved filler wire 20 is received in the bore of the contact tip 39, the filler wire 20 contacts the bore at two locations. Rubbing can occur at the locations as the filler wire 20 passes through the bore, causing the bore to become oval. This wear can cause a greater potential variance in a point in which the filler wire 20 enters the weld pool.

To deposit titanium at a rate of 5 kilogram/hour using a 1.6 mm diameter wire, the filler wire 20 must be fed through the contact tip 56 at about 9.5 meters per minute. This high feeding speed can cause significant abrasion of the bore of the contact tip 39 such that the contact tip 39 can “wear out” after a short period of time and need replacement. As the layers are added, the final product “leans” because of a combination of wire cast and wire guide bore wear that causes the solidified metal in the melt pool to be pushed or steer to one side by the incoming wire.

### SUMMARY

In a featured embodiment, a plasma arc welding system includes at least two wire delivery mechanisms and at least two wires. Each of the two wires is delivered by one of the at least two wire delivery mechanisms.

In another embodiment according to the previous embodiment, power source includes a negative output terminal and a positive output terminal. One of the at least two wire delivery mechanisms is connected to the negative output terminal, and the other of the at least two wire delivery mechanisms is connected to the positive output terminal of the power source.

In another embodiment according to any of the previous embodiments, the power source is a low voltage direct current power source.

In another embodiment according to any of the previous embodiments, the power source is a low voltage alternating current power source.

In another embodiment according to any of the previous embodiments, the at least two wires are electrically isolated from each other.

In another embodiment according to any of the previous embodiments, the at least two wire delivery mechanisms are disposed 180° relative to each other.

In another embodiment according to any of the previous embodiments, the at least two wire delivery mechanisms are disposed approximately 30° relative to each other.

In another embodiment according to any of the previous embodiments, the at least two wires are disposed 0° to 180° from each other.

In another embodiment according to any of the previous embodiments, the at least two wire delivery mechanisms include four wire delivery mechanisms and the at least two wires comprise four wires, and one of the four wires is directed through one of the four wire delivery mechanisms to form a single weld puddle with a plasma welding arc.

In another embodiment according to any of the previous embodiments, the at least two wires create an alloy of metals in a common weld puddle.

In another embodiment according to any of the previous embodiments, a spectrometer analyzes a metallurgy of the common weld pool in real time during a deposition process.

In another embodiment according to any of the previous embodiments, the common weld puddle is formed by a gas tungsten arc welding process, a laser beam, or an electron beam device.

In another embodiment according to any of the previous embodiments, each of the at least two wires have a different composition.

In another embodiment according to any of the previous embodiments, each of the at least two wires have a different diameter.

In another embodiment according to any of the previous embodiments, a delivery speed of each of the at least two wires is independently controlled.

In another embodiment according to any of the previous embodiments, a ratio of alloying elements is varied during a deposition process to customize material properties at any given position within a deposited structure.

In another embodiment according to any of the previous embodiments, a feeding motion at least one of the at least two wires is pulsed.

In another embodiment according to any of the previous embodiments, the at least two wires include a first filler wire and a second filler wire, and the at least two wire delivery mechanisms include a first wire delivery mechanism with a first contact tip and a second wire delivery mechanism with a second contact tip, and the first filler wire and the second filler wire exit the first contact tip and the second contact tip, respectively, to be directed onto a surface of a substrate or a weld puddle.

In another embodiment according to any of the previous embodiments, the first filler wire and the second filler are directed into a plasma welding arc.

In another embodiment according to any of the previous embodiments, the first filler wire and the second filler wire are directed into a plasma welding arc or a weld puddle from any direction.

In another featured embodiment, a plasma arc welding system includes a power source including a negative output terminal and a positive output terminal. At least two wire delivery mechanisms are included. One of the at least two wire delivery mechanisms is connected to the negative output terminal, and the other of the at least two wire delivery mechanisms is connected to the positive output terminal of the power source. At least two wires are each delivered by one of the at least two wire delivery mechanisms.

### BRIEF DESCRIPTION OF THE DRAWINGS

FIG. 1 illustrates a welding torch assembly;

FIG. 2 illustrates the welding torch assembly with a filler wire pre-heated with a direct current power source;

FIG. 3 illustrates the welding torch assembly the filler wire pre-heated with an alternating current power source;

FIG. 4a illustrates a profile formed by plasma arc welding using filler wire to additively manufacture an object;

FIG. 4b illustrates arc blow associated with direct current heating of the filler wire used to additively manufacture the object;

FIG. 4c illustrates arc weaving associated with alternating current heating of the filler wire used to additively manufacture the object;

FIG. 5a illustrates a perspective view of a welding torch assembly with two wires pre-heated with a direct current power source;

FIG. 5b illustrates another perspective view of the welding torch assembly with two wires pre-heated with the direct current power source;

FIG. 6 illustrates another perspective view of the welding torch assembly with two wires pre-heated with the direct current power source;

FIG. 7a illustrates a perspective view of a welding torch assembly with two wires having a tight access;

FIG. 7b illustrates a bottom view of the welding torch assembly with the two heated wires of FIGS. 7a;

FIG. 7c illustrates a perspective view of the welding torch assembly with the two heated wires of FIGS. 7a;

FIG. 7d illustrates another perspective view of the welding torch assembly with the two heated wires of FIG. 7a;

FIG. 7e illustrates a perspective view of the wire welding torch assembly with two non-heated wires with a tight access;

FIG. 8a illustrates a perspective view of a welding torch assembly with four non-heated wires;

FIG. 8b illustrates another perspective view of the welding torch assembly with four non-heated wires;

FIG. 9a illustrates a perspective view a perspective view of a welding torch assembly with four heated wires;

FIG. 9b illustrates another perspective view of the welding torch assembly with four heated wires;

FIG. 9c illustrates another perspective view of the welding torch assembly with four heated wires;

FIG. 9d illustrates another perspective view of the welding torch assembly with four heated wires;

FIG. 10 illustrates a 3D printer including a plasma arc welding torch assembly to additively manufacture an object; and

FIG. 11 illustrates the object formed by additive manufacturing.

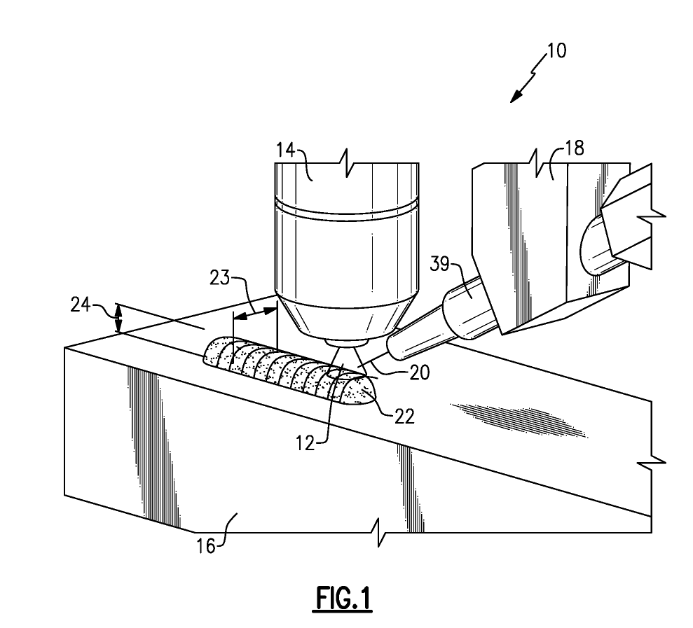

### DETAILED DESCRIPTION

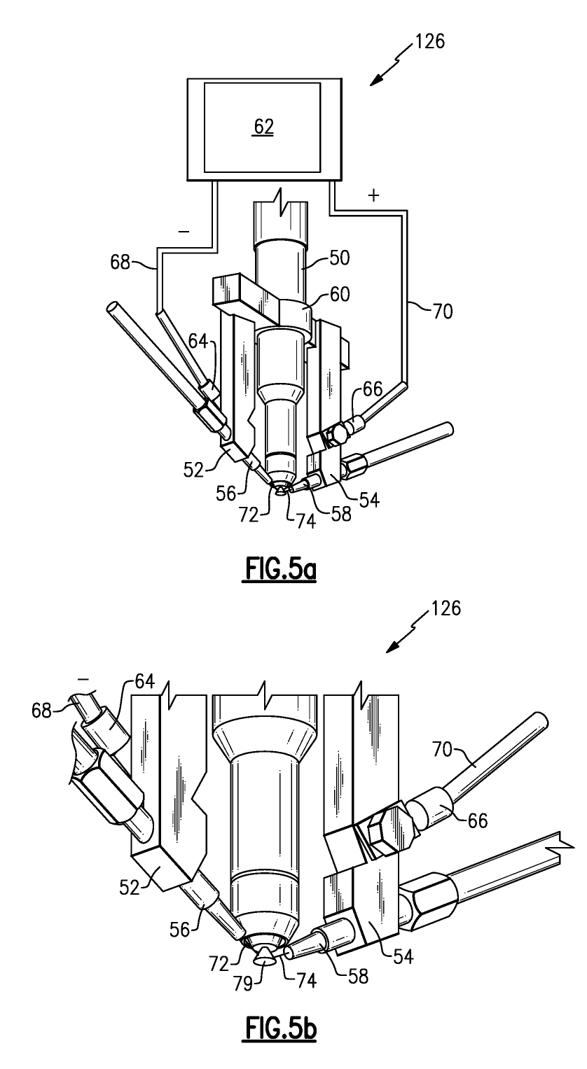

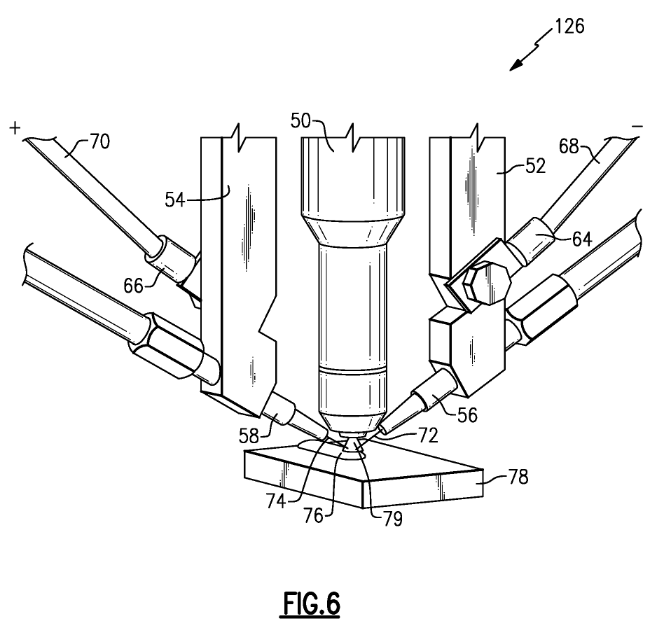

FIGS. 5a and 5b illustrate a plasma arc welding torch assembly 126 including a plasma arc welding torch 50 and a first filler wire 72 and a second filler wire 74 pre-heated by a power source 62. The plasma arc welding torch 50 includes a first filler wire guide 52 and a second filler wire guide 54 fitted with a first contact tip 56 and a second contact tip 58, respectively, mounted on an electrically insulative filler wire guiding mechanism 60 (wire guide or bracket) attached to the plasma arc welding torch 50. The power source 62 is a direct current low voltage power source, as described above. The power source 62 includes a negative output connected through a negative supply cable 68 to the first filler wire guide 52 at a negative connection point 64 and a positive output connected through a positive supply cable 70 to the second filler wire guide 5 at a positive connection point 66. The flow of current causes the filler wires 72 and 74 to become very hot, even though no arc is present. In one example, an angle between the first filler wire 72 and the second filler wire 74 is approximately 180°. In another example, an angle between the first filler wire 72 and the second filler wire 74 is approximately 0° to 180°.

The only wire heating current path from the direct current power source 62 is for current to flow through the negative supply cable 68 to the negative connection point 64, through the first filler wire guide 52, through the first contact tip 56, and along a first filler wire 72. Provided the first filler wire 72 is in contact with the second filler wire 74, current will continue to flow through the second filler wire 74, through the second contact tip 58, through the second filler wire guide 54, through the positive supply cable 70, through the positive connection point 66 and back to the direct current power source 62.

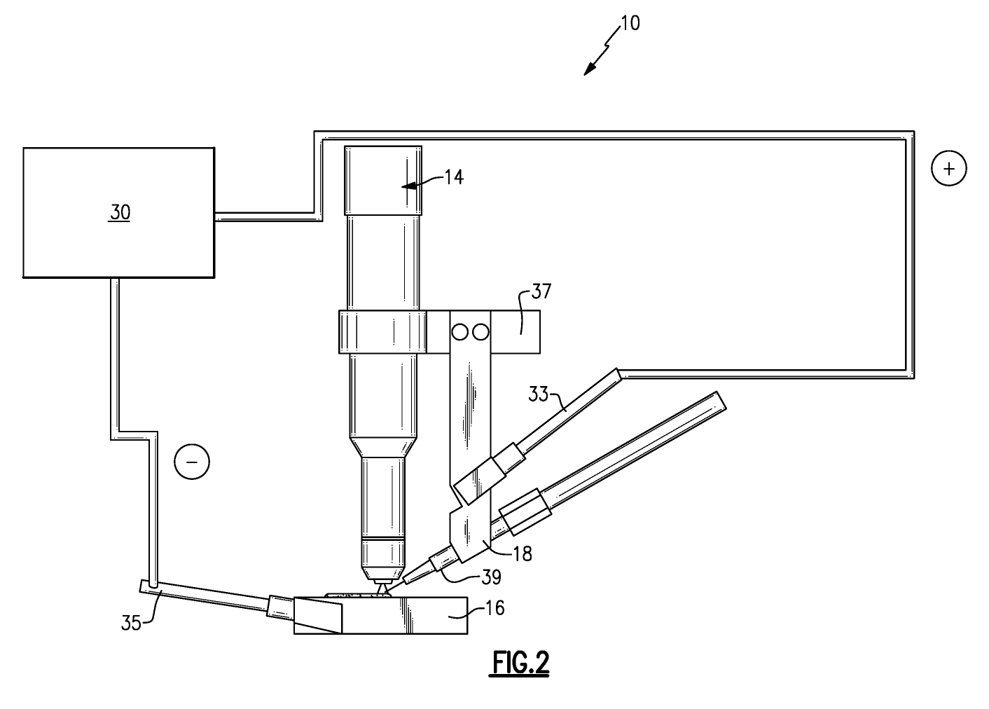

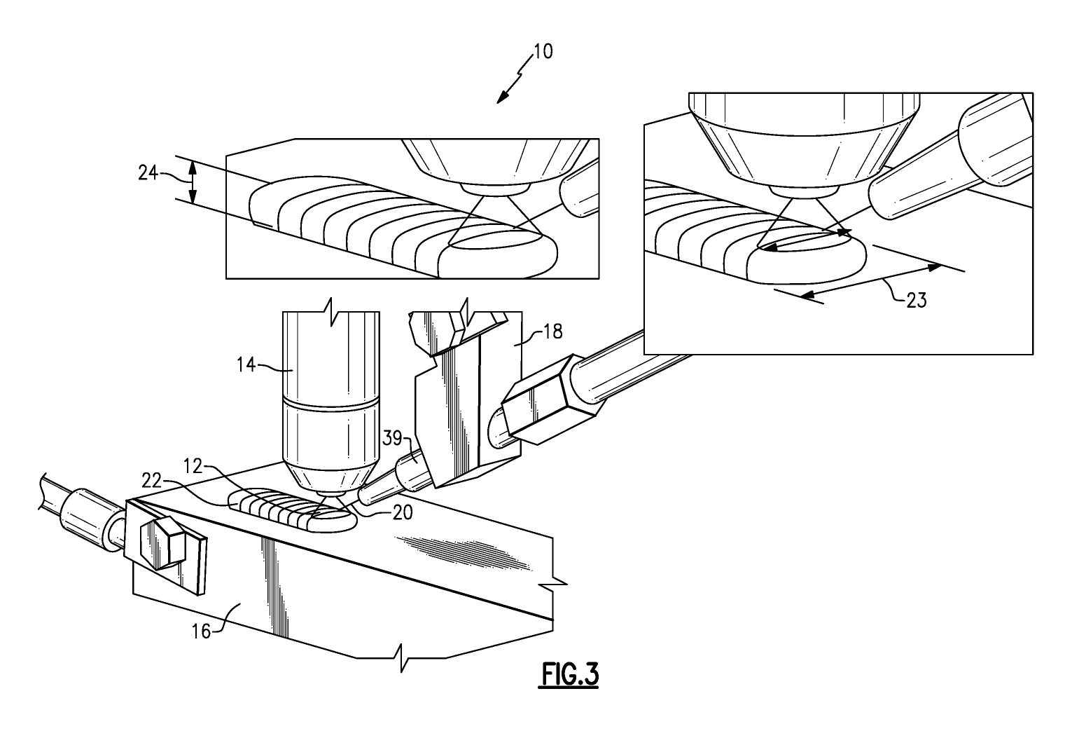

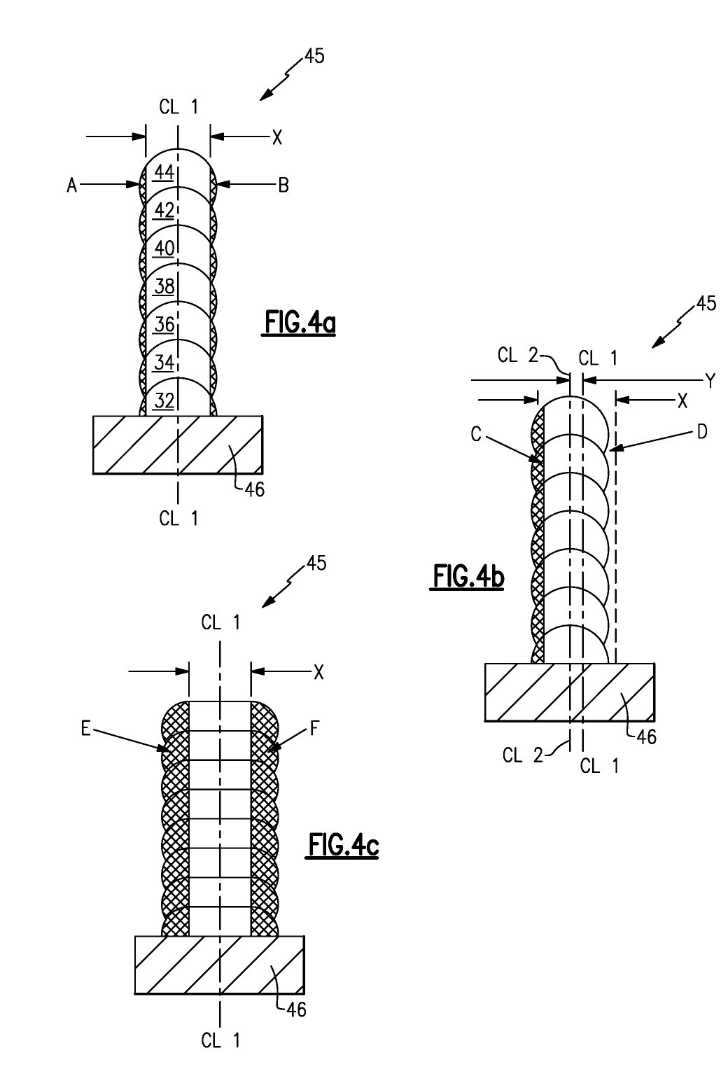

As shown in FIG. 6, electrical continuity and therefore current flow through the filler wire guides 52 and 54 is through the contact each of the filler wire guides 52 and 54 with a molten weld puddle 76 on a parent metal 78. Heating the filler wires 72 and 74 with a direct current power source 62 provides two advantages. First, if points of impingement of the filler wires 72 and 74 in the molten puddle 76 are close (just a few millimeters apart), almost all of the energy evolved at the positive connection and the negative connection within the respective filler wires 72 and 74 is generated across the body of the molten weld puddle 76 and not within the parent metal 78. Dilution of the filler wires 72 and 74 with the parent metal 78 is greatly reduced. The efficiency of the heating of the filler wires 72 and 74, compared to a single filler wire positively connected as described in FIG. 2, rises from around 66% (about ⅔) to close to 100%, with consequential increases in the deposition rate of the filler wires 72 and 74 for the same applied wire heating current. The deposition rate for the double filler wires 72 and 74 can be around 12 kilograms per hour. The magnetic fields surrounding the filler wires 72 and 74 have much less of an impact on the path of a plasma arc 79 as there is a degree of self-cancelling between the opposing magnetic fields surrounding each of the filler wires 72 and 74.

In one example, the first filler wire 72 and the second filler wire 74 exiting the first contact tip 56 and the second contact tip 58 are directed into the plasma arc 79. In another example, the first filler wire 72 and the second filler wire 74 exiting the first contact tip 56 and the second contact tip 58 are directed into either the molten weld puddle 76 or the plasma arc 79 from any direction.

The magnetic field surrounding the filler wires 72 and 74 self-cancel, eliminating any deflection of the plasma arc 79. If the filler wires 72 and 74 contact the parent metal 78, just in front of the molten weld puddle 76, the contact closes the direct current heating circuit and pre-heats the filler wires 72 and 74, allowing an increased deposition rate. If one of the filler wires 72 and 74 is lifted off of the parent metal 78, pre-heating still occurs. The molten weld puddle 76 and the plasma arc 79 remain stable. Conduction between the two filler wires 72 and 74 continues because of the intense plasma (electrically conductive) gas present in the plasma arc 79. If both the filler wires 72 and 74 are significantly misaligned (such as due to cast or bore wear of the wire guide tip) and both the filler wires 72 and 74 are lifted off the parent metal 78, the conductive arc column is entirely relied on to complete the pre-heating process. In this case, the plasma arc 79 and the molten weld puddle 76 remain stable. Finally, if one filler wire 72 and 74 is fed faster than the other, and both the filler wires 72 and 74 are fed into the plasma arc 79, and the plasma arc 79 suffers no deflection. The molten weld puddle 76 is stable, and the deposition process is highly controlled.

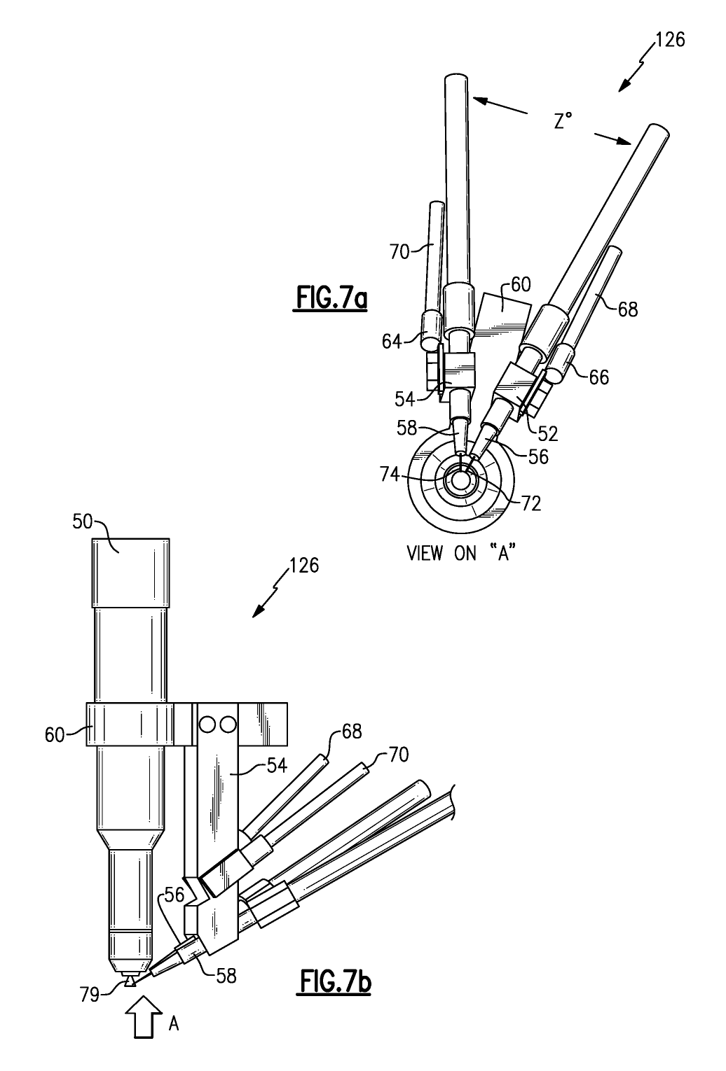

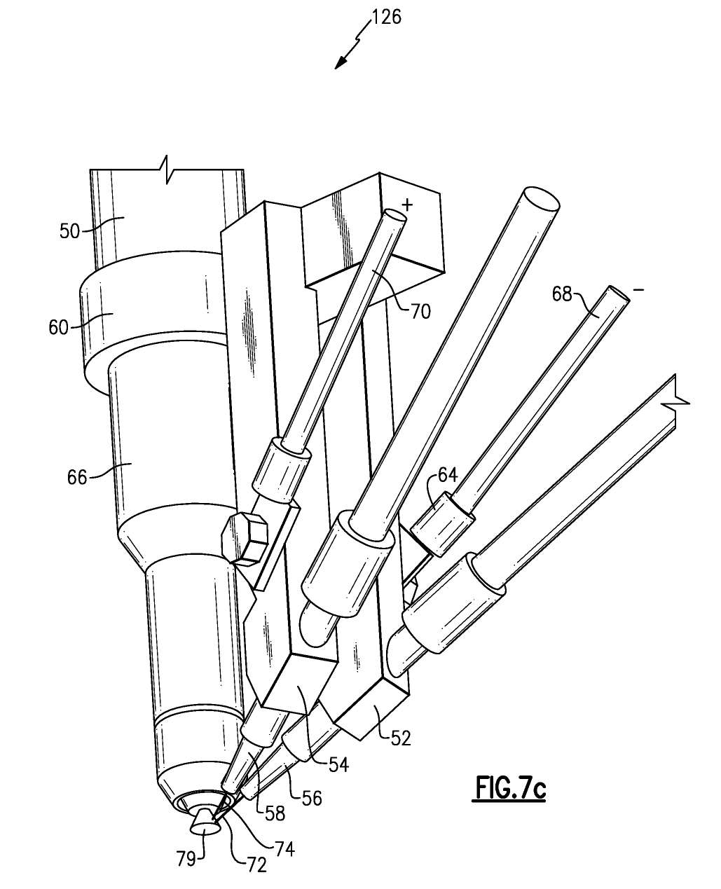

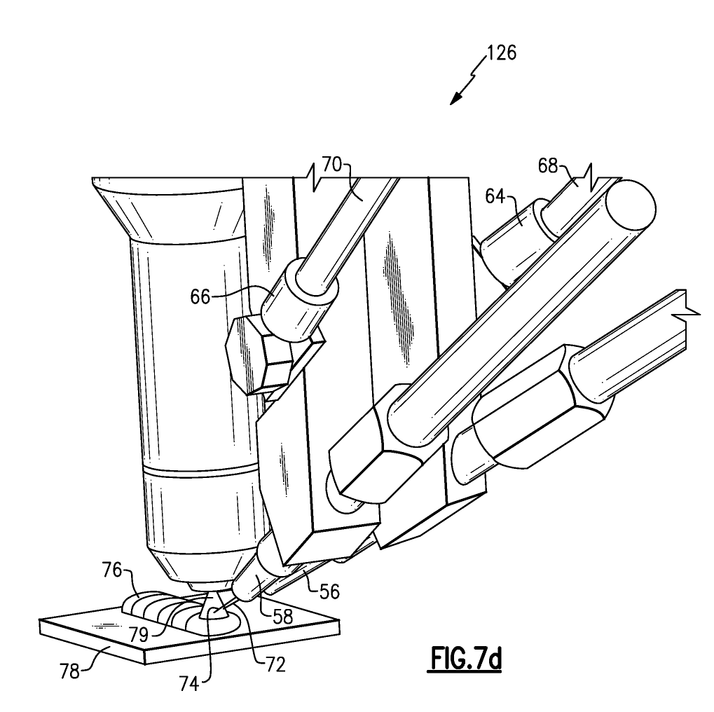

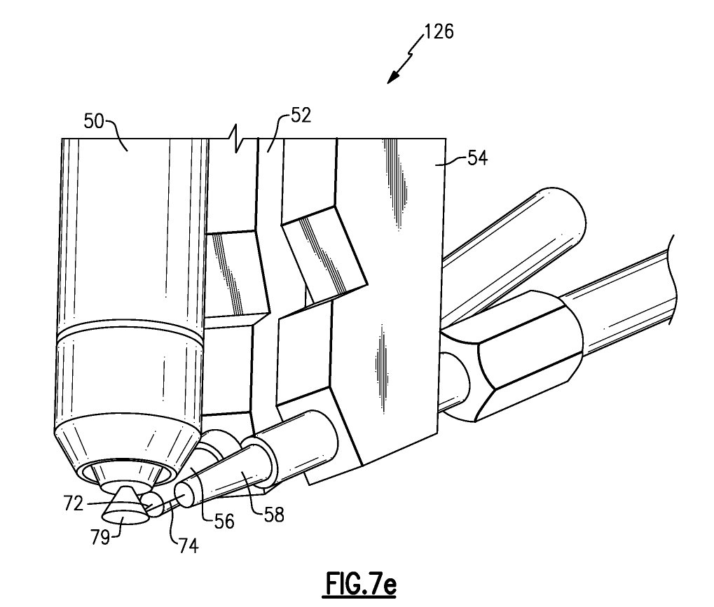

FIGS. 7a, 7b, 7c, 7d and 7e illustrate an arrangement where an angle between the filler wires 72 and 74 (as well as the filler wire guides 52 and 54, respectively) is Z°. In one example, Z is less than 90°. In one example, the filler wires 72 and 74 are approximately 30° from each other. This orientation is more compact and also reduces interaction between the plasma arc 79 and the magnetic fields surrounding the filler wires 72 and 74 during operation with the direct current power source 62 for resistive wire heating.

In the example of FIGS. 7a, 7b, 7c and 7d, the positive supply cable 70 and the negative supply cable 68 provide the plasma arc welding torch assembly 126 hot wire capability. In FIG. 7e, the plasma arc welding torch assembly 126 does not include a positive supply cable and a negative supply cable, providing a non-hot wire configuration.

The power source 62 to heat the filler wires 72 and 74 can also be an alternating current low voltage power source, as described above. However, an alternating current power source can result in more disturbance of the weld puddle 76 as compared to the direct current power source. Additionally, more variables are introduced into the process with an alternating current power source, further complicating the regulation and repeatability of an already complex process.

Gains in the deposition rate using two filler wires 72 and 74 heated with the direct current power source 62 can be more than double the deposition rate achieved when using a single filler wire resistance heated with a direct current power source because there is little, if any, energy “lost” in heating the parent metal 78.

The deposition rate of a single cold wire is around 2 kilograms per hour, and the deposition rate of a single heated wire (by a direct current power source) is around 4 kilograms per hour. The two filler wires 72 and 74 can be deposited by heating with a direct current power source 62 process in a stable manner and at a deposition rate that can exceed 12 kilograms per hour without any measurable increase in dilution of the deposit with the parent metal 78. This is a very significant improvement in productivity over the present methods described above.

When two filler wires 72 and 74 are employed, each filler wire 72 and 74 can be made of a different material composition so that when the filler wires 72 and 74 melt and mix in the weld puddle 76, a new mixture or binary alloy can be created. Many possibilities exist in making weld deposits that include elements in a ratio that may not be commercially available in the form of a single wire. In cladding and additive manufacturing, varying the relative proportions of the filler wires 72 and 74 can form structures having properties that can be varied at different locations (depending on the mixing ratio). This allows the composition of the mixture or alloy to be tailored to specific needs at any given point within the structure.

There are numerous advantages to using two filler wires 72 and 74 in creating and printing metal parts. Directing the two filler wires 72 and 74 to a common point greatly stabilizes the melt weld puddle 76, even when both the filler wires 72 and 74 have significant cast. To achieve a deposition rate of 5 kilogram/hour, the wire feeding speed of each filler wire 72 and 74 can be halved compared (4.75 meters per minute) the wire feeding speed of a single wire. This is beneficial when operating the printing process because wear in the wire guide tip bores is related to the feeding speed of the filler wires 72 and 74, and halving the wire feeding speed can lead to a four-fold or greater life improvement for the wire guide tip. The feeding motion of the filler wires 72 and 74 can also be pulsed to change the grain structure or morphology of the weld puddle 76.

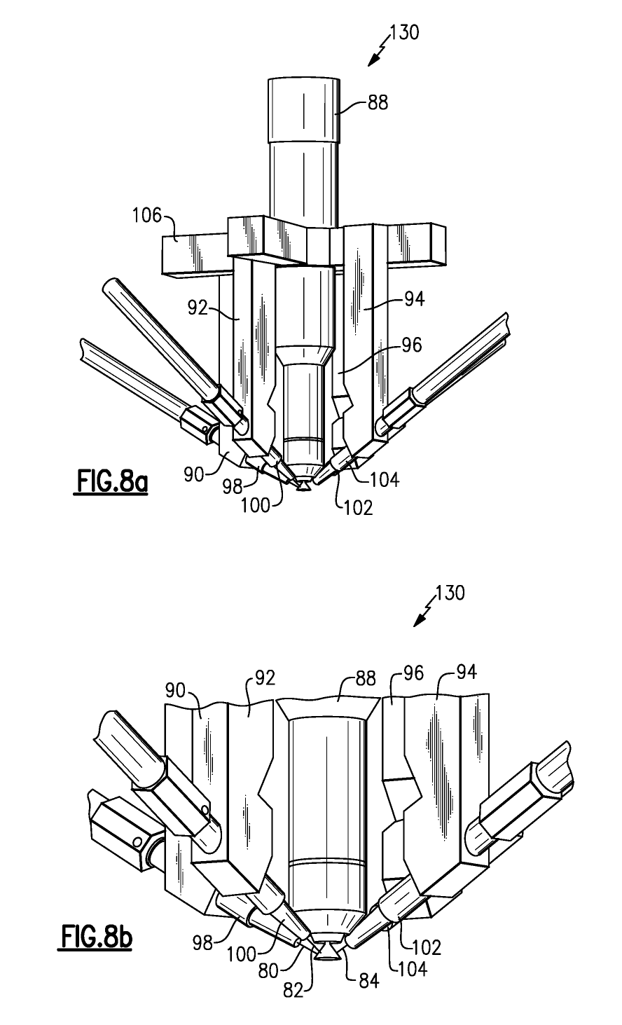

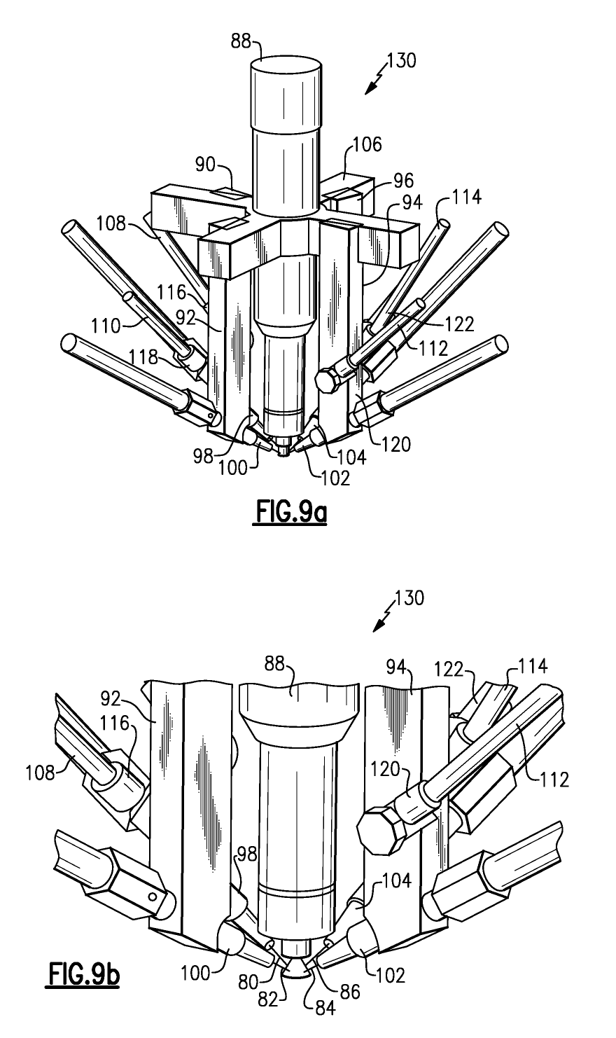

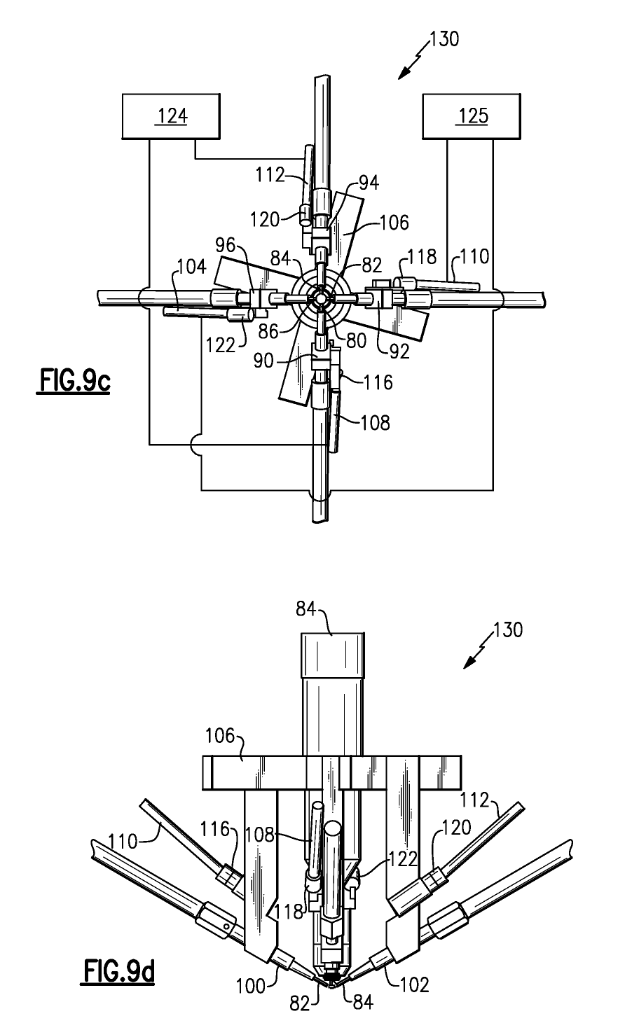

FIGS. 8a and 8b shows a plasma arc welding torch assembly 130 including additional pairs of wires that can create materials employed in additive manufacturing. The plasma arc welding torch assembly 130 includes two pairs of filler wires; a first pair of filler wires including a first filler wire 80 and a second filler wire 82 and a second pair of filler wires including a third filler wire 84 and a fourth filler wire 86 (shown in FIG. 9b). The filler wires 80, 82, 84 and 86 are arranged around a centrally located plasma arc welding torch 88.

The plasma arc welding torch 88 includes a first filler wire guide 90, a second filler wire guide 92, a third filler wire guide 94 and a fourth filler wire guide 96 that receive the first filler wire 80, the second filler wire 82, the third filler wire 84 and the fourth filler wire 86, respectively, that feed the filler wires 80, 82, 84 and 86 into the weld puddle 76. The first filler wire guide 90, the second filler wire guide 92, the third filler wire guide 94 and the fourth filler wire guide 96 are mounted on an electrically insulative filler wire guiding mechanism 106 (wire guide or bracket) attached to the plasma arc welding torch 88 and are each fitted with a first contact tip 98, a second contact tip 100, a third contact tip 102 and a fourth contact tip 104, respectively.

The use of the four filler wires 80, 82, 84 and 86 comprised of different elements or compositions provides many advantages. Direct current resistively heating 2 pairs of filler wires (described below) should further double the deposition rates (from about 12 kilograms per hour to about 24 kilograms per hour).

Additionally, many of the metallic alloys of specific interest in the additive manufacturing industry include four or less primary elements. For example, there are many titanium alloys that are created by alloying titanium with aluminum, vanadium and molybdenum. Selecting four filler wires 80, 82, 84 and 86 made of these four materials, and varying the rates at which each of these four filler wires 80, 82, 84 and 86 are fed into a weld puddle 76, can allow for the production of the following alloys:
Ti-8Al-1Mo-1V (UNS R54810)
Ti-6Al-4V (UNS R56400)
Ti-7Al-4Mo (UNS R56740)
Ti-8Mo-8V-2Fe-3Al (UNS R58820)
   Many aluminum alloys, particularly the high strength ones favored by the aerospace industry, can be created using wires that constitute the alloying elements involved.

Commercially available wire feeding units can cope with wires of differing diameters and can do so with great accuracy. Real time data logging and measurement capabilities ensure that the respective percentages of the wires can be ensured. Real time analysis of the composition of the alloy can be confirmed by observing the weld pool domain with a spectrometer.

Given the capability that a plasma arc welding torch assembly 130 including four filler wires 80, 82, 84 and 86 has, materials containing more than four alloying elements can be easily produced by using individual wires that include two or more of the elements required. In many cases, some of the elements may only be a very small percentage of the desired alloy to the extent that a difference in feeding speeds of the wires to obtain the required percentage was beyond the practical differential available with the wire feeding mechanisms. In this case, reducing a diameter of the filler wires 80, 82, 84 and 86 including the minor alloying element(s) would reduce the cross sectional area and therefore a volume fed into the weld puddle 76, for any given speed, compared to a larger diameter wire.

In the example provided of the four titanium alloys, the ability to “manufacture” these different compositions from their basic elements represents a cost savings compared to purchasing and stocking the individual alloy types in wire form. Another advantage is that the filler wires 80, 82, 84 and 86 do not have to be changed over with a new alloy composition when needed. Control algorithms for the filler wire guides 90, 92, 94 and 96 ensure that the filler wires 80, 82, 84 and 86 are added to the weld puddle 76 in the correct proportions to create the desired alloy blend.

The plasma arc welding torch 88 melts the four filler wires 80, 82, 84 and 86, causing the filler wires 80, 82, 84 and 86 to mix and adhere to either a substrate or a weld deposit (as in additive manufacturing). Other sources of energy can be used. The plasma arc welding torch 88 can be a gas tungsten arc welding torch, a laser beam or an electron beam process.

FIGS. 9a, 9b, 9c and 9d illustrates the plasma arc welding torch assembly 130 including a first power source 124 and a second power source 125 that can resistively heat two pairs of filler wires (the four filler wires 80, 82, 84 and 86) and can double a deposition rate compared to the twin heated wire technique to about 24 kilograms per hour. The first power source 124 and the second power source 125 can be either a direct current low voltage power source or an alternating current low voltage power source. That is, both the first power source 124 and the second power source 125 can be direct current low voltage power sources, they can both be alternating current low voltage power sources, or one can be a direct current low voltage power source and the other can be an alternating current low voltage power source.

The plasma arc welding torch assembly 130 includes two pairs of supply cables. A first pair of supply cables includes a first positive supply cable 108 and a first negative supply cable 112, and a second pair of supply cables includes a second positive supply cable 110 and a second negative supply cable 114. The first power source 124 includes a positive output connected through the first positive supply cable 108 to the first filler wire guide 90 and a negative output connected through the first negative supply cable 112 to the second filler wire guide 94. The second power source 125 includes a positive output connected through the second positive supply cable 110 to the third filler wire guide 92 and a negative output connected through the second negative supply cable 114 to the fourth filler wire guide 96. In this example, the supply cables 108, 110, 112 and 114 are spaced approximately 90° apart.

It is also possible for the first power source 124 to be connected to the first positive supply cable 108 and the second negative supply cable 114 and the second power source 125 to be connected to the second positive supply cable 110 and the first negative supply cable 112. The plasma arc welding torch assembly 130 can include any number of pairs of supply cables. That is, there is one power source for each pair of supply cables. For example, if there are four pairs of supply cables, there are four power sources.

The wire heating current path from the power sources 124 and 125 is through the first negative supply cables 112 and 114, respectively, to the negative connection points 120 and 122, respectively, through the wire guides 94 and 96, respectively, through the contact tips 102 and 104, respectively, and through the filler wires 82 and 86, respectively. Provided the filler wires 82 and 86 are in contact with the filler wires 80 and 84, current will flow through the filler wires 82 and 86, respectively, through the contact tips 98 and 100, respectively, through the filler wire guides 90 and 92, respectively, through the first positive supply cables 108 and 110, respectively, that are connected to the filler wire guides 90 and 92, respectively, at positive connections 116 and 118, respectively, and back to the power sources 124 and 125, respectively. Electrical continuity and current flow through the filler wire guides 90, 92, 94 and 96 is through the contact each of the wires makes with a molten weld puddle on the parent metal 78.

Magnetic fields surrounding the filler wire 80, 82, 84, 86 have a lower impact on a path of a plasma arc because there is a degree of self-cancelling between opposing magnetic fields surrounding the filler wires 80, 82, 84, 86.

The plasma arc welding torch assembly 130 can be used in welding, cladding or additive manufacturing applications.

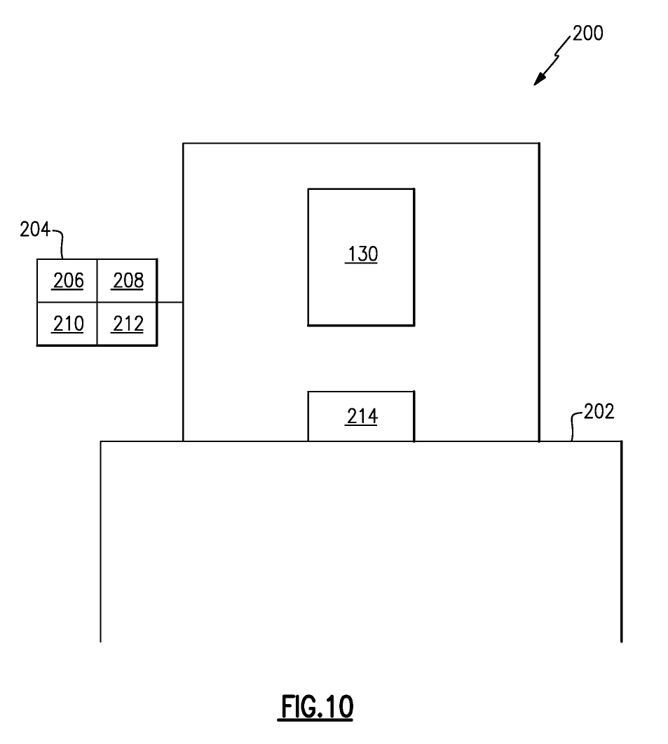

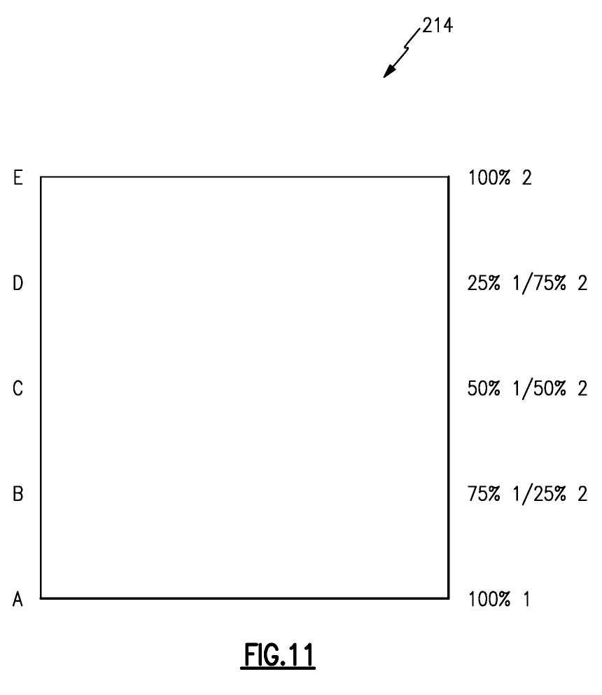

FIG. 10 schematically illustrates an additive manufacturing system 200 (or a 3D printer) including the plasma arc welding torch assembly 130 to create an object 214. The plasma arc welding torch assembly 130 can move relative to a table 202, or the table 202 can move relative to the plasma arc welding torch assembly 130. A computer 204 (including storage 206, a microprocessor 208, an input 210 (such as a mouse or keyboard), and a monitor 212) moves the plasma arc welding torch assembly 130 or the table 202 based on an algorithm to create the object 214.

FIG. 11 illustrates the object 214. The example is for illustrative purposes only. For example, the object 214 is made of material 1 at location A and material 2 at location E. The computer 204 can provide a signal based on the algorithm to the plasma arc welding torch assembly 130 to add each of the filler wires 80, 82, 84 and 86 at a rate that will deposit the filler wires 80, 82, 84 and 86 to create material 1 at location A. As the plasma arc welding torch assembly 130 continues to deposit material, the composition needs to have a lower percentage of material 1 and a higher percentage of material 2. As the depositing continues, the computer 204 provides a signal to the plasma arc welding torch assembly 130 based on the algorithm to change the rate of the filler wires 80, 82, 84 and 86. The composition of the object 214 at location B is approximately 75% material 1 and approximately 25% material 2. The composition of the object 214 at location C is approximately 50% material 1 and approximately 50% material 2. The composition of the object 214 at location C is approximately 25% material 1 and approximately 75% material 2. The composition of the object 214 at location E is approximately 100% material 2. The change in the composition is based on the algorithm provided by the computer 204 to determine the rate of movement of each of the filler wires 80, 82, 84 and 86. The object can also be created employing the filler wires 72 and 74 of the plasma arc welding torch assembly 126.

The changes in the composition are gradual such that the composition changes as the deposition of the material builds up from location A to location B to location C to location D to location E. That is, as the deposit builds up from location A to location B, the amount of material 1 decreases and the amount of material 2 increases gradually. As a result, there can be a unique composition of material at any location of the object 214. Objects 214 that are made by casting can be made by additive manufacturing.

By employing two or more filler wires, erosion of the bore of the contact tip (wire guide tip) bore can be reduced. Additionally, employing two or more filler wires greatly improves the stability and placement accuracy of multiple deposits when layered.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A plasma arc welding system comprising:
at least two wire delivery mechanisms; and
at least two wires, wherein each of the two wires is delivered by one of the at least two wire delivery mechanisms.

2. The system as recited in claim 1 including a power source including a negative output terminal and a positive output terminal, wherein one of the at least two wire delivery mechanisms is connected to the negative output terminal, and the other of the at least two wire delivery mechanisms is connected to the positive output terminal of the power source.

3. The system as recited in claim 2 wherein the power source is a low voltage direct current power source.

4. The system as recited in claim 2 wherein the power source is a low voltage alternating current power source.

5. The system as recited in claim 1 wherein the at least two wires are electrically isolated from each other.

6. The system as recited in claim 1 the at least two wire delivery mechanisms are disposed 180° relative to each other.

7. The system as recited in claim 1 wherein the at least two wire delivery mechanisms are disposed approximately 30° relative to each other.

8. The system as recited in claim 1 wherein the at least two wires are disposed 0° to 180° from each other.

9. The system as recited in claim 1 wherein the at least two wire delivery mechanisms comprise four wire delivery mechanisms and the at least two wires comprise four wires, and one of the four wires is directed through one of the four wire delivery mechanisms to form a single weld puddle with a plasma welding arc.

10. The system as recited in claim 1 wherein the at least two wires create an alloy of metals in a common weld puddle.

11. The system as recited in claim 10 including a spectrometer to analyze a metallurgy of the common weld pool in real time during a deposition process.

12. The system as recited in claim 1 wherein the common weld puddle is formed by a gas tungsten arc welding process, a laser beam, or an electron beam device.

13. The system as recited in claim 1 wherein each of the at least two wires have a different composition.

14. The system as recited in claim 1 wherein each of the at least two wires have a different diameter.

15. The system as recited in claim 1 wherein a delivery speed of each of the at least two wires is independently controlled.

16. The system as recited in claim 1 wherein a ratio of alloying elements is varied during a deposition process to customize material properties at any given position within a deposited structure.

17. The system as recited in claim 1 wherein a feeding motion at least one of the at least two wires is pulsed.

18. The system as recited in claim 1 wherein the at least two wires comprise a first filler wire and a second filler wire, and the at least two wire delivery mechanisms comprise a first wire delivery mechanism with a first contact tip and a second wire delivery mechanism with a second contact tip, and the first filler wire and the second filler wire exit the first contact tip and the second contact tip, respectively, to be directed onto a surface of a substrate or a weld puddle.

19. The system as recited in claim 18 wherein the first filler wire and the second filler are directed into a plasma welding arc.

20. The system as recited in claim 18 wherein the first filler wire and the second filler wire are directed into a plasma welding arc or a weld puddle from any direction.

21. A plasma arc welding system comprising:
a power source including a negative output terminal and a positive output terminal;
at least two wire delivery mechanisms, wherein one of the at least two wire delivery mechanisms is connected to the negative output terminal, and the other of the at least two wire delivery mechanisms is connected to the positive output terminal of the power source; and
at least two wires each delivered by one of the at least two wire delivery mechanisms.
